(19) United States
(12) Patent Application Publication
(10) Pub. No.: US 2002/0181932 A1
(43) Pub. Date: Dec. 5, 2002

(54) Self-contained audio and video recording system

(76) Inventor: Paul Azous, New York, NY (US)

Correspondence Address: Richard W. Goldstein, 2071 Clove Road, Staten Island, NY, 10304, US

(21) Appl. No.: 09/871,795

(22) Filed: Jun. 1, 2001

(51) Int. Cl. H04N 5/76; H04N 5/225

(52) U.S. Cl. 386/46; 386/117

(57) ABSTRACT

A self-contained audio and video recording system including a personal containment booth dimensioned for receiving more than one individual therein. The personal containment booth has an openable door exposing a hollow interior thereof. A video and audio recording system is disposed within the personal containment booth. The video and audio recording system includes a monitor, a hard drive, a control panel, a keyboard, a video recorder, a microphone, and a speaker. The video and audio recording system has a pair of payment activation slots therein. The video and audio recording system includes a pair of disk outputs. The control panel includes buttons to control recording and playing back of audio and video.

### BACKGROUND OF THE INVENTION

The present invention relates to a self-contained audio and video recording system and more particularly pertains to creating a personal compact disc for listening and viewing.

The use of combination media devices is known in the prior art. More specifically, combination media devices heretofore devised and utilized for the purpose of recording audio and video are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,688,105 to Bloch discloses a self-service video production, allowing a user to create a video tape of himself with various backgrounds. U.S. Pat. No. 4,965,673 to Bozo discloses a booth with means for recording both audio and video onto a blank video tape.

While these devices fulfill their respective, particular objective and requirements, the aforementioned patents do not describe a self-contained audio and video recording system for creating a personal compact disc for listening and viewing.

In this respect, the self-contained audio and video recording system according to the present invention substantially departs from the conventional concepts and designs of the prior art, and in doing so provides an apparatus primarily developed for the purpose of creating a personal compact disc for listening and viewing.

Therefore, it can be appreciated that there exists a continuing need for a new and improved self-contained audio and video recording system which can be used for creating a personal compact disc for listening and viewing. In this regard, the present invention substantially fulfills this need.

### SUMMARY OF THE INVENTION

In the view of the foregoing disadvantages inherent in the known types of combination media devices now present in the prior art, the present invention provides an improved self-contained audio and video recording system. As such, the general purpose of the present invention, which will be described subsequently in greater detail, is to provide a new and improved self-contained audio and video recording system which has all the advantages of the prior art and none of the disadvantages.

To attain this, the present invention essentially comprises a personal containment booth dimensioned for receiving more than one individual therein. The personal containment booth has an openable door exposing a hollow interior thereof. The openable door has a mirror disposed on a back surface thereof. The personal containment booth has a forward wall and opposed side walls. The personal containment booth has at least one chair secured therein. A video and audio recording system is disposed within the personal containment booth. The video and audio recording system includes a monitor, a hard drive, a control panel, a keyboard, a video recorder, a pair of microphones, and a pair of speakers. The video and audio recording system has a pair of payment activation slots therein. The slots include a currency slot and a credit card slot. The hard drive includes a pair of disk outputs. The pair of disk outputs includes a compact disk output and a mini disk output. The video and audio recording system includes an internal printer with a sticker output. The control panel includes buttons to control recording and playing back of audio and video. A video background monitor is adapted for being removably positioned on the openable door of the personal containment booth. The video background monitor is in communication with the video and audio recording system.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved self-contained audio and video recording system which has all the advantages of the prior art combination media devices and none of the disadvantages.

It is another object of the present invention to provide a new and improved self-contained audio and video recording system which may be easily and efficiently manufactured and marketed.

It is a further object of the present invention to provide a new and improved self-contained audio and video recording system which is of durable and reliable construction.

An even further object of the present invention is to provide a new and improved self-contained audio and video recording system which is susceptible of a low cost of manufacture with regard to both materials and labor, and which accordingly is then susceptible of low prices of sale to the consuming public, thereby making such a self-contained audio and video recording system economically available to the buying public.

Even still another object of the present invention is to provide a new and improved self-contained audio and video recording system for creating a personal compact disc for listening and viewing.

Lastly, it is an object of the present invention to provide a new and improved self-contained audio and video recording system including a personal containment booth dimensioned for receiving more than one individual therein. The personal containment booth has an openable door exposing a hollow interior thereof. A video and audio recording system is disposed within the personal containment booth. The video and audio recording system includes a monitor, a hard drive, a control panel, a keyboard, a video recorder, a pair of microphones, and a pair of speakers. The video and audio recording system has a pair of payment activation slots therein. The video and audio recording system includes a pair of disk outputs. The control panel includes buttons to control recording and playing back of audio and video.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the self-contained audio and video recording system constructed in accordance with the principles of the present invention.

FIG. 2 is a front view of an interior of the personal containment booth.

FIG. 3 is a front view of a video background monitor of the present invention.

FIG. 4 is a front view of a hard drive of the present invention.

FIG. 5 is a front view of a control panel of the present invention.

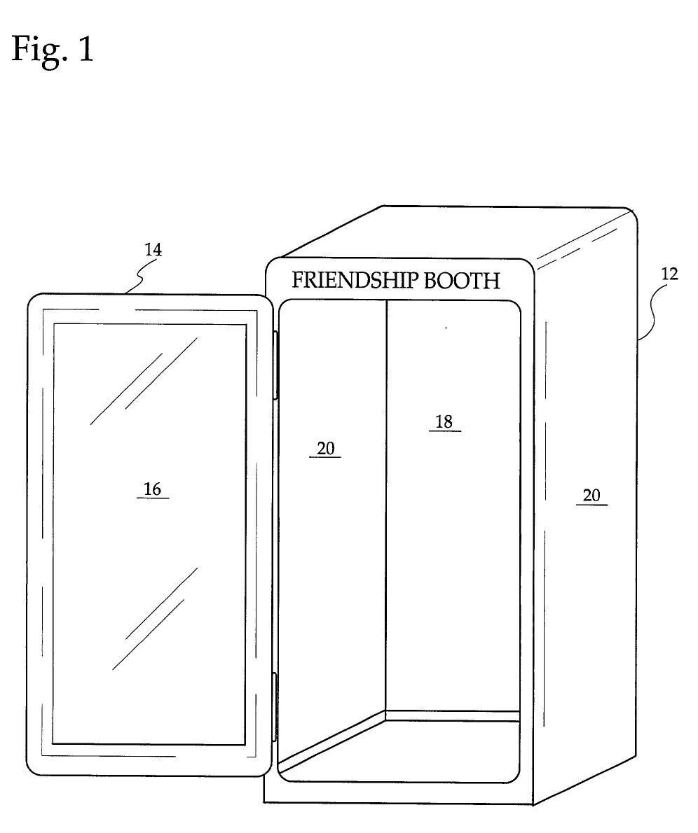

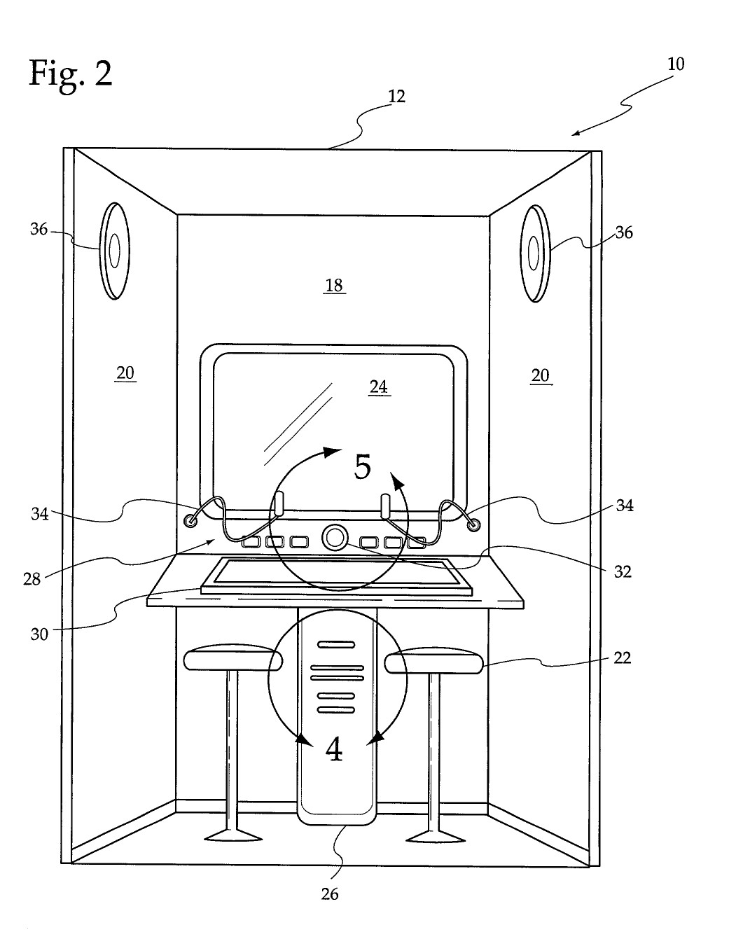

The same reference numerals refer to the same parts through the various figures.

### DESCRIPTION OF THE PREFERRED EMBODIMENT

With reference now to the drawings, and in particular, to figures one through five thereof, the preferred embodiment of the new and improved self-contained audio and video recording system embodying the principles and concepts of the present invention and generally designated by the reference number 10 will be described.

Specifically, it will be noted in the various figures that the device relates to a self-contained audio and video recording system for creating a personal compact disc for listening and viewing. In its broadest context, the device consists of a personal containment booth, a video and audio recording system, and a video background monitor. Such components are individually configured and correlated with respect to each other so as to attain the desired objective.

The personal containment booth 12 is dimensioned for receiving more than one individual therein. In the preferred embodiment, the personal containment booth 12 is dimensioned for comfortably holding two adults. The personal containment booth 12 has an openable door 14 exposing a hollow interior thereof. The openable door 14 has a mirror 16 disposed on a back surface thereof. The personal containment booth 12 has a forward wall 18 and opposed side walls 20. The personal containment booth 12 has at least one chair 22 secured therein.

The video and audio recording system is disposed within the personal containment booth. The video and audio recording system includes a monitor 24, a hard drive 26, a control panel 28, a keyboard 30, a video recorder 32, a microphone 34, and a speaker 36. The monitor 24 is capable of displaying video images thereon. The video and audio recording system has a pair of payment activation slots 38 therein. The slots 38 control the activation of the video and recording system. The slots 38 include a currency slot 40 and a credit card slot 42. In order to activate the present invention, the user must deposit the requisite monies through either of the slot's 38 using either hard currency or a credit card. Once the monies have been received, the video and recording system will be activated. The video and audio recording system delivers video images to the monitor 24 and audio signals to the speaker 36. The hard drive 26 is capable of storing audio and video recordings. The video recordings are captured by the video recorder 32. The audio recordings are captured by the microphone 34. The video and audio recordings are also recorded on internal tapes. Alternately, a user could provide his own tape to capture his recordings. The video and audio recording system includes a pair of disk outputs 44 for ejecting the internal tapes. The pair of disk outputs 44 include a compact disk output 46 and a mini disk output 48. The user will select the type of disk desired through use of the keyboard 30. The video and audio recording system includes an internal printer having a sticker output 50. The keyboard 30 allows information to be typed into the video and audio recording system for the internal printer to print the information on a sticker whereupon the sticker will be ejected for use with an ejected internal tape. The control panel 28 includes buttons 52 to control recording and playing back of audio and video. The control panel 28 allows stored video and audio recordings to play through the monitor 24 and speaker 36 and also be edited on the internal tapes.

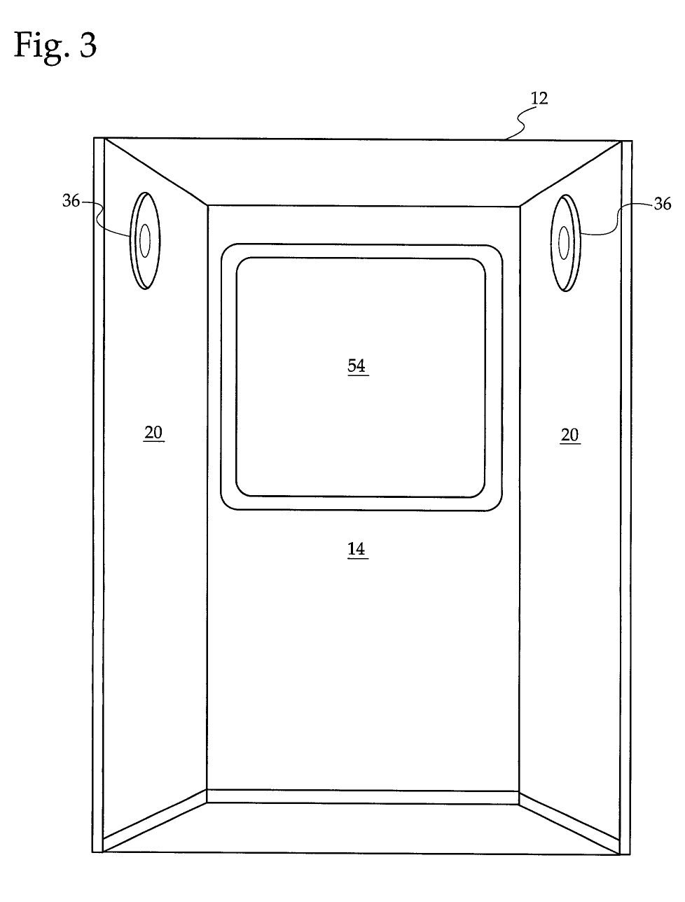

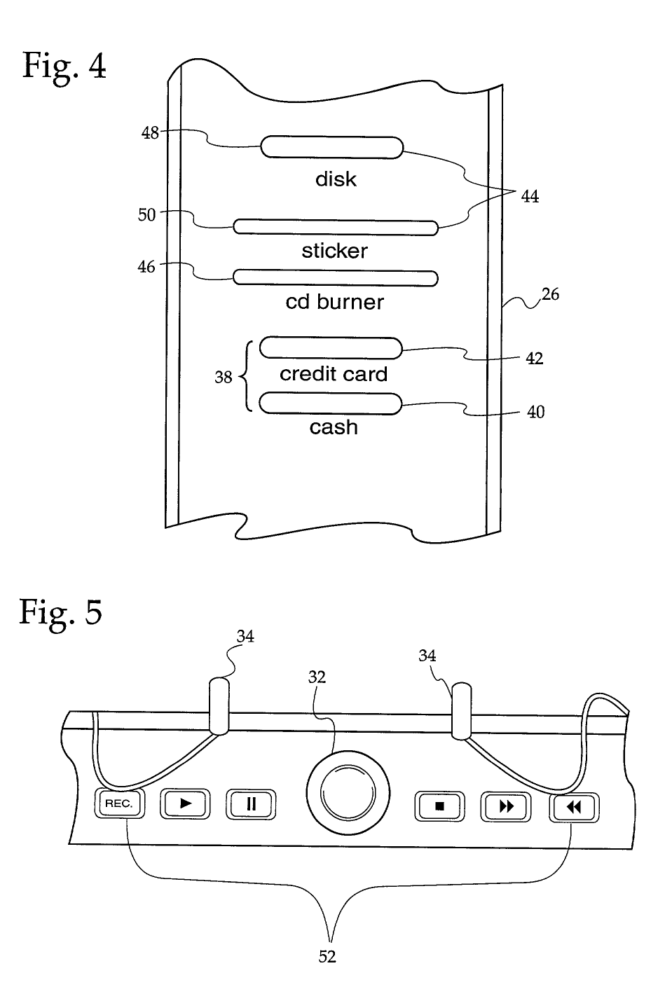

The video background monitor 54 is adapted for being removably positioned on the openable door 14 of the personal containment booth 12. Note FIG. 3. The video background monitor 54 is in communication with the video and audio recording system for playing stored music and video recordings thereon.

The present invention is essentially a soundproof booth designed to record audio, video, or both and create a compact disk with a custom sticker for the user to take home when finished. The user first enters the personal containment booth 12 and activates the system by payment through either of the activation slots 38. The monitor 24 will then show instructions on how to record either the audio or video. When finished, the hard drive 26 will eject the selected disk, sticker and a receipt.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A self-contained audio and video recording system for creating a personal compact disc for listening and viewing comprising, in combination:
a personal containment booth dimensioned for receiving more than one individual therein, the personal containment booth having an openable door exposing a hollow interior thereof, the openable door having a mirror disposed on a back surface thereof, the personal containment booth having a forward wall and opposed side walls, the personal containment booth having at least one chair secured therein;
a video and audio recording system disposed within the personal containment booth, the video and audio recording system including a monitor, a hard drive, a control panel, a keyboard, a video recorder, a microphone, and a speaker, the monitor being capable of displaying video images thereon, the video and audio recording system delivering video images to the monitor and audio signals to the speaker, the hard drive being adapted for storing video and audio recordings, the video recordings being captured by the video recorder, the audio recordings being captured by the microphone, the video and audio recordings being recordable on internal tapes, the video and audio recording system having a pair of payment activation slots therein, the slots including a currency slot and a credit card slot, the video and audio recording system including a pair of disk outputs for ejecting the internal tapes, the pair of disk outputs including a compact disk output and a mini disk output, the video and audio recording system including an internal printer having a sticker output, the internal printer printing information typed into the video and audio recording system by the keyboard, the control panel including buttons to control recording and playing back of audio and video, the control panel allowing stored video and audio recordings to be played through the monitor and speaker and edited on the internal tapes; and
a video background monitor adapted for being removably positioned on the openable door of the personal containment booth, the video background monitor being in communication with the video and audio recording system for playing stored music and video recordings thereon.

2. A self-contained audio and video recording system for creating a personal compact disc for listening and viewing comprising, in combination:
a personal containment booth dimensioned for receiving more than one individual therein, the personal containment booth having an openable door exposing a hollow interior thereof; and
a video and audio recording system disposed within the personal containment booth, the video and audio recording system including a monitor, a hard drive, a control panel, a keyboard, a video recorder, a microphone, and a speaker, the monitor being capable of displaying video images thereon, the video and audio recording system delivering video images to the monitor and audio signals to the speaker, the hard drive being adapted for storing video and audio recordings, the video recordings being captured by the video recorder, the audio recordings being captured by the microphone, the video and audio recordings being recordable on internal tapes, the video and audio recording system having a pair of payment activation slots therein, the video and audio recording system including a pair of disk outputs for ejecting the internal tapes, the control panel including buttons to control recording and playing back of audio and video, the control panel allowing stored video and audio recordings to be played through the monitor and speaker and edited on the internal tapes.

3. The self-contained audio and video recording system as set forth in claim 2, wherein the openable door of the personal containment booth has a mirror disposed on a back surface thereof.

4. The self-contained audio and video recording system as set forth in claim 2, wherein the personal containment booth has at least one chair secured therein.

5. The self-contained audio and video recording system as set forth in claim 2, wherein the pair of payment activation slots includes a currency slot and a credit card slot.

6. The self-contained audio and video recording system as set forth in claim 2, wherein the pair of disk outputs includes a compact disk output and a mini disk output.

7. The self-contained audio and video recording system as set forth in claim 2, wherein the video and audio recording system includes an internal printer having a sticker output, the internal printer printing information typed into the hard drive by the keyboard.

8. The self-contained audio and video recording system as set forth in claim 2, and further including a video background monitor adapted for being removably positioned on the openable door of the personal containment booth, the video background monitor being in communication with the video and audio recording system for playing stored music and video recordings thereon.
